(19) United States
(12) Patent Application Publication
(10) Pub. No.: US 2026/0331917 A1
(43) Pub. Date: Oct. 22, 2026

(54) METHODS AND DEVICES FOR AUTONOMOUS HIGH ELECTRICITY DEMAND RESPONSE

(71) Applicant: BLUWAVE INC., Ottawa (CA)

(72) Inventors: Thomas TRIPLET, Ottawa (CA); Kevin SHIMOTAKAHARA, Ottawa (CA)

(21) Appl. No.: 19/182,043

(22) Filed: Apr. 17, 2025

(51) Int. Cl. H02J 3/175; G05B 13/02; H02J 103/30

(52) U.S. Cl. CPC H02J 3/175; G05B 13/027; H02J 2103/30

(57) ABSTRACT

Systems and methods for reducing electricity consumption during periods of peak demand are disclosed. A feature vector representative of a given future time period is provided to a machine learning model trained to generate an embedding therefrom. An inference embedding of the given future time period is received from the machine learning model. A likelihood metric indicative of a likelihood that the given future time period is a peak demand time period is computed by comparing the inference embedding with at least one comparator embedding. An electronic signal of a recommended reduction of electricity consumption during the given future time period is generated, taking into account the likelihood metric.

### FIELD

This disclosure relates to electrical power systems, and more particularly relates to reduction of electricity consumption during periods of peak demand.

### BACKGROUND

In many parts of the world, electricity transmission and distribution networks that deliver power to residential and industrial customers are divided into territorial regions governed by organizations referred to as system operators. System operators are responsible for the operation of a wholesale electricity market, in which power plants in their region sell their energy generation to distributors or large individual market participants. Additionally, system operators drive the planning involved in maintaining and expanding their region's infrastructure to retain its capacity to satisfy consumer demand.

System operators may create price incentives to influence customer electricity consumption behavior in a way that reduces the peak instantaneous demand observed in the region. The rationale for this includes a desire to avoid or delay the need to upgrade the capacity of existing infrastructure to keep up with demand. Such infrastructure upgrades are expensive and can negatively impact both producers and consumers.

In accordance with such price incentives, electricity customers can significantly reduce the price they must pay for their electricity by simply not consuming electricity during a small set of time periods throughout the year when the region's electrical power system is under the most stress.

However, it is challenging to know when exactly these time periods will occur each year. This poses a significant challenge for consumers who wish to optimize their electricity usage and reduce costs.

### SUMMARY

In accordance with an aspect, there is provided a computer-implemented system for reducing electricity consumption during periods of peak demand. The system includes a processing subsystem that includes one or more processors and one or more memories coupled with the one or more processors. The processing subsystem is configured to cause the system to: provide a feature vector representative of a given future time period to a machine learning model trained to generate an embedding therefrom; receive from the machine learning model an inference embedding of the given future time period; compute a likelihood metric indicative of a likelihood that the given future time period is a peak demand time period, by comparing the inference embedding with at least one comparator embedding; and generate an electronic signal of a recommended reduction of electricity consumption during the given future time period, taking into account the likelihood metric.

In such system, the at least one comparator embedding may be representative of a historical peak demand time period.

In such system, the at least one comparator embedding may reflect an electricity demand threshold.

In such system, the given future time period may be a given future hour, and the likelihood metric may indicate a likelihood that the given future hour is a peak demand hour.

In such system, the given future time may be at least one day in the future.

In such system, the machine learning model may be trained using training data including historical time periods of peak demand.

In such system, the machine learning model may be trained using a Siamese neural network architecture.

In such system, the machine learning model may be trained using training data organized into anchor examples, positive examples, and negative examples, each corresponding to a respective historic time period.

In such system, the likelihood metric may be computed using a distance metric measuring a distance between the inference embedding and the at least one comparator embedding.

In such system, the at least one comparator embedding may include a plurality of comparator embeddings, and the distance metric is an average of distances between the inference embedding and the plurality of comparator embeddings.

In such system, the electronic signal of a recommended reduction of electricity consumption may be transmitted to a device operated by an end user.

In such system, the recommended reduction may include deactivating or reducing an activation level of an end user asset.

In such system, the electronic signal of a recommended reduction of electricity consumption may be transmitted to a device operated by a system operator.

In such system, the recommended reduction may include issuance of a curtailment request by the system operator.

In accordance with another aspect, there is provided a computer-implemented method for reducing electricity consumption during periods of peak demand. The method includes providing a feature vector representative of a given future time period to a machine learning model trained to generate an embedding therefrom; receiving from the machine learning model an inference embedding of the given future time period; computing a likelihood metric indicative of a likelihood that the given future time period is a peak demand time period, by comparing the inference embedding with at least one comparator embedding; and generating an electronic signal of a recommended reduction of electricity consumption during the given future time period, taking into account the likelihood metric.

Such method may further include training the machine learning model using a Siamese neural network architecture.

Such method may further include organizing training data into anchor examples, positive examples, and negative examples, each corresponding to a respective historic time period.

Such method may further include training the machine learning model using training data including historical time periods of peak demand.

Such method may further include transmitting the electronic signal of a recommended reduction of electricity consumption to a device operated by an end user.

In such method, the recommended reduction may include deactivating or reducing an activation level of an end user asset.

Such method may further include transmitting the electronic signal of a recommended reduction of electricity consumption to a device operated by a system operator.

In such method, the recommended reduction includes issuance of a curtailment request by the system operator.

Many further features and combinations thereof concerning embodiments described herein will appear to those skilled in the art following a reading of the instant disclosure.

### BRIEF DESCRIPTION OF THE DRAWINGS

In the figures,

FIG. 1 is a schematic diagram of an example electrical power system, in accordance with an embodiment;

FIG. 2 is a network diagram of a network environment of an example electrical power system, in accordance with an embodiment;

FIG. 3A is a schematic diagram of a prediction system, in accordance with an embodiment;

FIG. 3B is a schematic diagram of an embedding generator of the prediction system of FIG. 3A, in accordance with an embodiment;

FIG. 4 shows an example output of the prediction system of FIG. 3A, in accordance with an embodiment;

FIG. 5 shows a distribution of risk scores as generated by the prediction system of FIG. 3A, in accordance with an embodiment;

FIG. 6, FIG. 7 and FIG. 8 each is a visualization of an approach to transforming a risk score to a recommendation, in accordance with an embodiment;

FIG. 9 shows graphs of accuracy of the prediction system of FIG. 3A, in accordance with an embodiment;

FIG. 10 is a schematic diagram of a configuration system, in accordance with an embodiment;

FIG. 11 is a schematic diagram of an example training data set, in accordance with an embodiment;

FIG. 12 is a schematic diagram of an example machine learning model, in accordance with an embodiment;

FIG. 13 is a flowchart of example operations performed at the prediction system of FIG. 3A and the configuration system of FIG. 10, in accordance with an embodiment;

FIG. 14 is a flowchart of example operations performed at the prediction system of FIG. 3A, in accordance with an embodiment; and

FIG. 15 is a schematic diagram of a computing device, in accordance with an embodiment.

These drawings depict exemplary embodiments for illustrative purposes, and variations, alternative configurations, alternative components and modifications may be made to these exemplary embodiments.

### DETAILED DESCRIPTION

Disclosed herein are embodiments of systems and methods for reducing electricity consumption during periods of peak demand. In some embodiments, such systems and methods can assist an end user (e.g., a consumer of electrical power) to predict periods of peak demand before they occur.

Based on such prediction, end users may adjust their electrical power consumption behaviour proactively. For example, end users may reduce their electrical power consumption during hours predicted to be periods of peak demand. In one example, an end user may avoid charging their electric vehicle during such periods. In another example, an end user may reduce their heating or cooling demands during such periods. In yet another example, an end user may avoid operation of certain machinery during such periods.

Conveniently, embodiments of systems and methods provided herein may enable end users to take advantage of price incentives, e.g., as may be offered by a system operator. For example, in Ontario, Canada, certain classes of end users can reduce their electricity bill by over half if they avoid consuming electricity during five specific hours each year. These five hours correspond to the top five daily peak electricity demand hours (i.e., the hour of the day during which the energy consumed by the Ontario electricity market was highest) observed each year.

Conveniently, embodiments of systems and methods provided herein, by reducing electricity consumption during periods of peak demand, may contribute to stability and efficiency of an electrical power system.

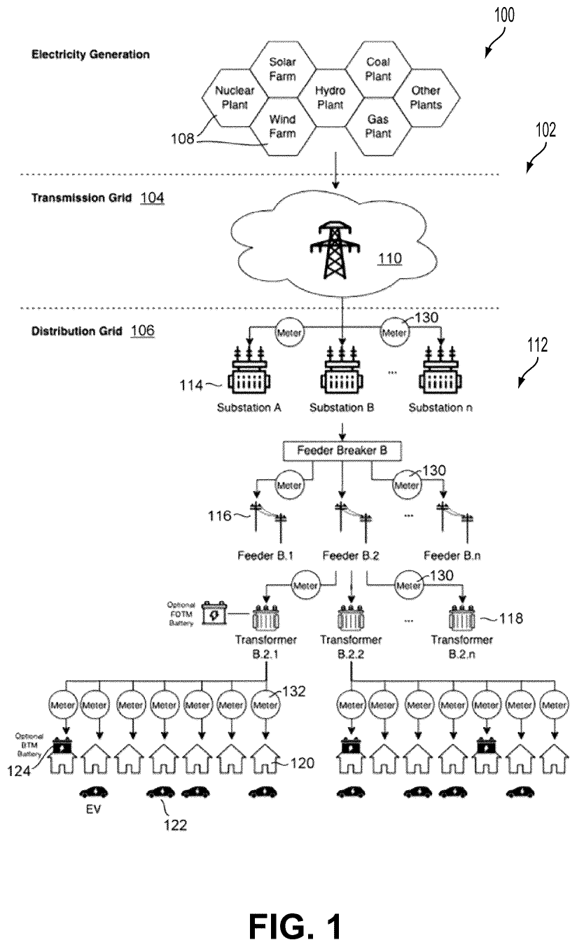

FIG. 1 depicts an example electrical power system 100, in accordance with an embodiment. An electrical power system generally refers to any system that involves the transmission and/or distribution of electrical power. An electrical power system may include a power grid 102, which is generally a network for transmission and distribution from electrical power producers to end users. In addition, an electrical power system may refer to only part of an electrical power grid. However, in general, the terms power system and power grid are used interchangeably herein. Furthermore, an electrical power grid generally refers to any power network or system, and is thus not limited to a conventional power grid.

An electrical power grid may be subdivided into several sub grids, for example, a power transmission grid 104 and a power distribution grid 106. A power grid generally comprises one or more power generating plants 108, power transmission infrastructure 110 to carry power long distances, and power distribution infrastructure 112 to deliver power to end users. Power generating plants 108 may include any types of power generation, such as fossil fuel (e.g., coal or gas), nuclear, and renewables such as solar, wind, and so on.

Power distribution infrastructure 112 may include one or more substations 114, for example, for stepping down the voltage from the transmission infrastructure to a lower voltage for the distribution infrastructure. Power distribution infrastructure 112 may include one or more feeders 116, which are electrical conductors, for example, for delivering power from substations 114 to locations further downstream in the distribution infrastructure 112, such as distribution transformers 118. Distribution transformers 118 may further step down the voltage from the feeder lines 116 to a lower voltage, for example, for delivery to end users 120. Users 120 may be associated with any type(s) of power customer, for example, a home or other building or dwelling. Users 120 may be associated with various equipment such as an electric vehicle (EV) charging station, a charge point, an EV 122, an ESS such as a battery energy storage system (BESS) 124, and so on.

A tree-like structure of the distribution grid 106 may be thought of as having multiple different branches, for example, from a substation to various feeders, or from a feeder to various transformers, and so on.

Power system 100 may have electrical meters, for example, distribution meters 130 and/or customer meters 132, at various locations in electrical power system 100. Meters may be used to measure any types of electrical parameters, such as current, voltage, power, and so on.

An example of power system infrastructure being overloaded is now described. Referring to FIG. 1, assume that it is around 5 pm on a work day during the summer when many homes are running the electric air conditioners of their homes, and several people in a neighborhood arrive back at home (for example, from work) in their EVs 122. In this example, the people in the neighborhood all live at homes that are serviced by transformer B.2.1 in FIG. 1. Upon arrival at home, they connect their EVs 122 to charge points at their homes 120, and the EVs 122 begin charging immediately. The people also turn on various electrical devices in their homes, such as stoves, ovens, and washing machines. The user demand during this on-peak time is very high.

As the users who live in homes serviced by transformer B.2.1 begin to own or use more EVs 122, the load on the subset of the power grid 106 infrastructure that services these people will increase. At a certain point, the number of EVs 122 at these homes will likely reach a point at which the demand (load) will at times exceed the operational limits of electrical components in the subset of the power grid 106 infrastructure that services these users, which includes transformer B.2.1. Exceeding the operational limits of the component(s) will constitute an overloading of this subset of the power grid 106, thereby potentially causing physical damage to at least some of the electrical components in the power grid 106, possibly including transformer B.2.1.

Load curtailment in electrical generation systems is an operational strategy employed by electrical system operators such as the Independent Electricity System Operator (IESO). This process involves the deliberate reduction in electrical power consumption by end users, especially during peak demand times or when a power grid is threatened by instability or outages.

An objective of load curtailment is to ensure the stability and reliability of the power grid. In moments when demand threatens to exceed the supply, either due to generation limitations or unforeseen demand spikes, curtailment can prevent system-wide blackouts and maintain service for at least some end users.

Curtailment also plays a pivotal role in economic efficiency. By reducing the load strategically, an operator can avoid running more expensive and often less environmentally-friendly auxiliary generation plants, thus saving on costs and minimizing environmental impact.

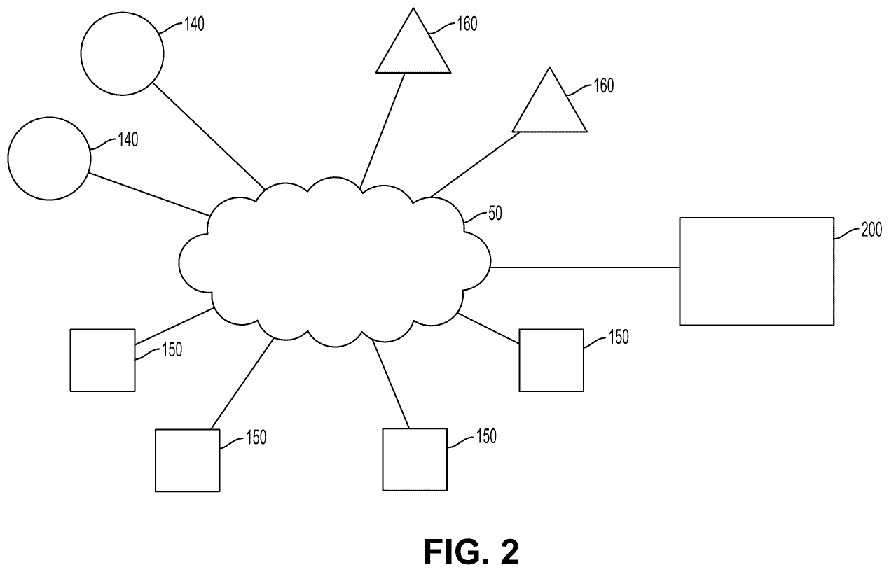

FIG. 2 is a diagram depicting a network environment of an electrical power system, in accordance with an embodiment. As depicted, this network environment includes a prediction system 200. Prediction system 200 is configured to predict future periods of peak demand and thereby facilitates the reduction of electricity consumption during such periods.

As depicted, prediction system 200 is interconnected with a plurality of data source devices 140, a plurality of end user assets 150, and a plurality of operator computing devices, by way of a communication network 50.

Each data source device 140 is configured to provide to prediction system 200 data useful for predicting future periods of peak demand. Some data source devices 140 provide data reflecting records of historical periods of peak demand. Some data source devices 140 provide data reflecting electricity demand such as, e.g., electricity demand at the time of a prediction, recorded electricity demand in preceding time period(s), and/or forecasted electricity demand in future time period(s). Some data source devices 140 provide data regarding weather such as, e.g., current weather at the time of a prediction, recorded weather in preceding time period(s), and/or forecasted weather in future time period(s).

Each end user asset 150 is an equipment or software operated by an end user. For example, end user assets 150 may include various electric vehicles (e.g., EV 122), electric vehicle chargers, smart thermostats, smart home software, or the like. In some embodiments, an end user asset 150 may also be a personal computing device capable of electronic communication with prediction system 200 such as, for example, a smart phone, a tablet computer, a laptop computer, a desktop computer, or the like.

Each operator computing device 160 is operated by an electrical system operator. An operator computing device 160 may communicate with prediction system 200, e.g., to receive recommendations to issue a curtailment request (also known as a demand and response event). A curtailment request may specify that load be reduced by a particular amount in a particular grid (or sub grid) during a particular time period. An operator computing device 160 may be a computer server device, a personal computer device, a cloud computing device, or the like.

Network 50 may include a packet-switched network portion, a circuit-switched network portion, or a combination thereof. Network 50 may include wired links, wireless links such as radio-frequency links or satellite links, or a combination thereof. Network 50 may include wired access points and wireless access points. Portions of network 50 could be, for example, an IPV4, IPv6, X.25, IPX, or similar network. Portions of network 50 could be, for example, a GSM, GPRS, 3G, LTE, or similar wireless network. Network 50 may include or be connected to the Internet. When network 50 is a public network such as the public Internet, it may be secured as a virtual private network.

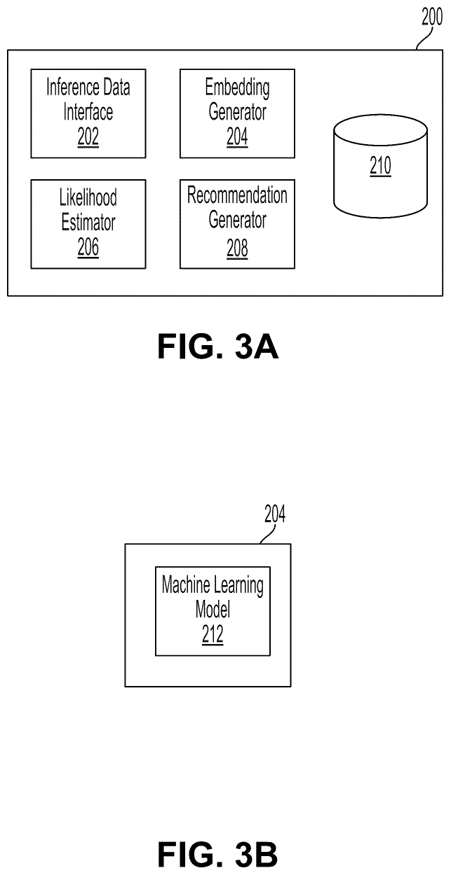

FIG. 3A is a schematic diagram of prediction system 200, in accordance with an embodiment. As depicted, prediction system 200 includes an inference data interface 202, an embedding generator 204, a likelihood estimator 206, a recommendation generator 208, and an electronic data store 210.

Inference data interface 202 is configured to receive data transmissions from one or more data source devices 140, e.g., by way of network 50. Such data transmissions encode data useful for predicting future periods of peak demand. The data may be used to generate inference data for input to a machine learning model. Inference data interface 202 may pre-process such data, e.g., by applying normalization to data values, filtering such data, removing outliers, or the like.

Inference data interface 202 processes the received data to generate a feature record of the inference data (e.g., in the form of a feature vector) for each particular future time period for which a prediction is to be made.

In some embodiments, inference data interface 202 generates a feature record to include one or more features relating to the future time period subject of a particular prediction, such as, for example:
hour of day in local time of the future time period for which the particular prediction is to be made;
day of week in local time of the future time period for which the particular prediction is to be made; and
month of year in local time of the future time period for which the particular prediction is to be made.

In some embodiments, the foregoing time-related features may be converted into a radial basis function, e.g., with one-hot encoding.

In some embodiments, inference data interface 202 generates a feature record to include one or more features relating to electricity demand, such as, for example:
(i) electricity demand observed when the prediction is to be made;
(ii) electricity demand observed during the time periods preceding (e.g., n hours before) when the prediction is to be made;
(iii) electricity demand forecasted for the future time period after when the particular prediction is to be made; and
(iv) for a given day in local time, the largest hourly forecasted demand value during that day.

Some of such features, such as, for example, feature (iv) may help account for seasonality effects, and may assist the model in extrapolation.

In some embodiments, the foregoing demand-related features may be expressed in kilowatts.

In some embodiments, inference data interface 202 generates a feature record to include one or more features related to observed weather or forecasted weather such as, e.g., current weather at the time of a prediction, recorded weather in preceding time period(s), and/or forecasted weather in future time period(s) including the particular future time period subject of the prediction to be made.

In some embodiments, these weather features may include one or more of temperature, humidity, humidex, heat index, wind speed, wind chill, etc., or other weather features that may impact demand for electricity consumption.

Embedding generator 204 is configured to generate feature embeddings using the feature records generated by inference data interface 202. Such feature embeddings generated from feature records of inference data may be referred to herein as inference embeddings.

As shown in FIG. 3B, embedding generator 204 includes a machine learning model 212 for generating feature embeddings, in accordance with an embodiment. Machine learning model 212 receives a feature record (e.g., in the form of a feature vector) as an input and generates a feature embedding as an output. Consequently, machine learning model 212 transforms a higher dimensionality feature record into a lower dimensionality feature embedding.

In such embodiments, machine learning model 212 is configured to transform input features (e.g., a feature vector) into embeddings that have smaller distances between each other when the input features are considered more similar to one another, and larger distances when the input features are considered less similar to one another.

In some embodiments, machine learning model 212 is trained to minimize a distance between (i) embeddings corresponding to time periods that are likely to be peak demand time periods, and (ii) feature embeddings of historical peak demand time periods. At the same time, machine learning model 212 is trained to maximize a distance between (i) feature embeddings corresponding to time periods that are unlikely to be peak demand time periods and (ii) feature embeddings of historical peak demand time periods.

Machine learning model 212 can be distinguished from models that make predictions or perform classifications.

In some embodiments, as further detailed below, machine learning model 212 implements a Siamese neural network architecture.

Referring again to FIG. 3A, likelihood estimator 206 is configured compute a likelihood metric indicative of a likelihood that a given future time period is a peak demand time period. Likelihood estimator 206 receives a feature embedding corresponding to the given future time.

In some embodiments, computation of the likelihood metric includes computation of a distance metric measuring a distance between (i) the feature embedding corresponding to the given future time, and (ii) at least one feature embedding of historical peak demand time periods. Such distance may be computed as a distance d(x, y) between two vectors x and y, which may, for example, be a Euclidean distance or similar distance that satisfies the following properties:
(i) non-negativity: d(x, y)≥0;
(ii) identity of indiscernibles: d(x, y)=0 if and only if x=y;
(iii) symmetry: d(x, y)=d(y, x);
(iv) triangle inequality: d(x, z)≤d(x, y)+d(y, z).

When multiple distances are computed, e.g., for multiple historical peak demand time periods, the distance metric may be computed as an average of the distances (e.g., a mean, median, or the like).

The distance metric is indicative of a likelihood that the given future time period is a peak demand time period. In some embodiments, a likelihood metric is computed as an inverse of the distance metric, so that the likelihood metric increases with respect to the likelihood that the given future time period is a peak demand time period. This likelihood metric may also be referred to as a risk metric or risk score representing a degree of risk that the given future time period is a peak demand time period.

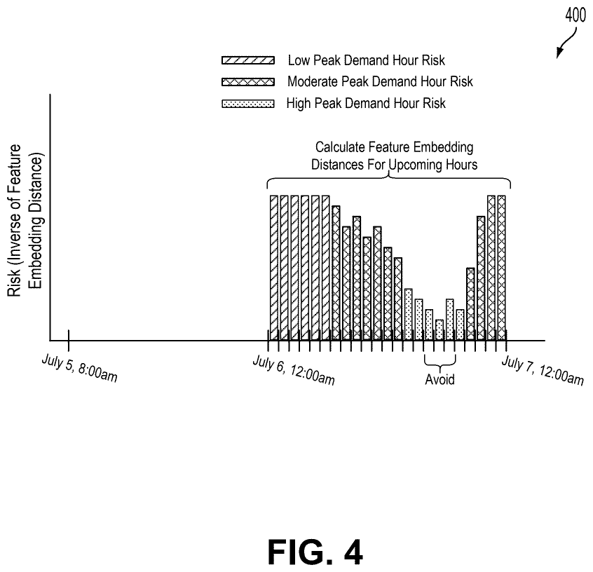

FIG. 4 depicts a visualization of an example output of likelihood estimator 206, in accordance with an embodiment. In this embodiment, time periods of peak demand are analyzed at a resolution of an hour. Consequently, likelihood estimator 206 generates a likelihood metric for each hour. In FIG. 4, graph 400 shows risk as a function of time, namely the computed risk for each hour of the next day being a peak demand hour.

A peak demand hour is an hour corresponding to daily peak demand that is among the top n peaks over the course of a long period of time (e.g., a year). In the case of the electricity market in Ontario, Canada, the times when the top five daily peaks occur over the course of a May to May annual period can significantly impact a certain class of customers' electricity consumption fees.

As depicted, prediction system 100 receives data known at July 5, 8:00 am. Such data is transformed into feature embeddings, each corresponding to an hour of the day ahead. For each hour in the day ahead, likelihood estimator 206 computes the average distance between (i) the feature embedding for that hour and (ii) feature embeddings for a set of historical peak demand hours. For each hour in the day ahead, this average distance is converted into an aforementioned risk score, which is shown for the July 6 12:00 am to July 7 12:00 am time frame. Lower values correspond to a higher risk of a particular hour of day being a peak demand hour.

The risk scores may be categorized into low, moderate, or high risk categories based on predefined thresholds. Recommendations for reduction of electricity consumption may be generated based on the risk category. For example, a recommendation that electricity consumption be avoided may be generated for hours that are categorized into the high risk category.

In some embodiments, the risk score can be normalized to aid interpretability. For example, risk scores may be divided by a predefined threshold. This threshold may be empirically determined such that feature embeddings above this threshold are highly likely to be a peak demand time period. This allows any risk score over the value of 1 to be interpreted as indicating high risk.

In some embodiments, thresholds may be dynamically calculated and used in place of predefined thresholds. For example, using the distribution of the risk scores over time, the top 20% may be classified as high risk, the lower 25% may be classified as low risk, while the remaining scores in between may be classified as moderate.

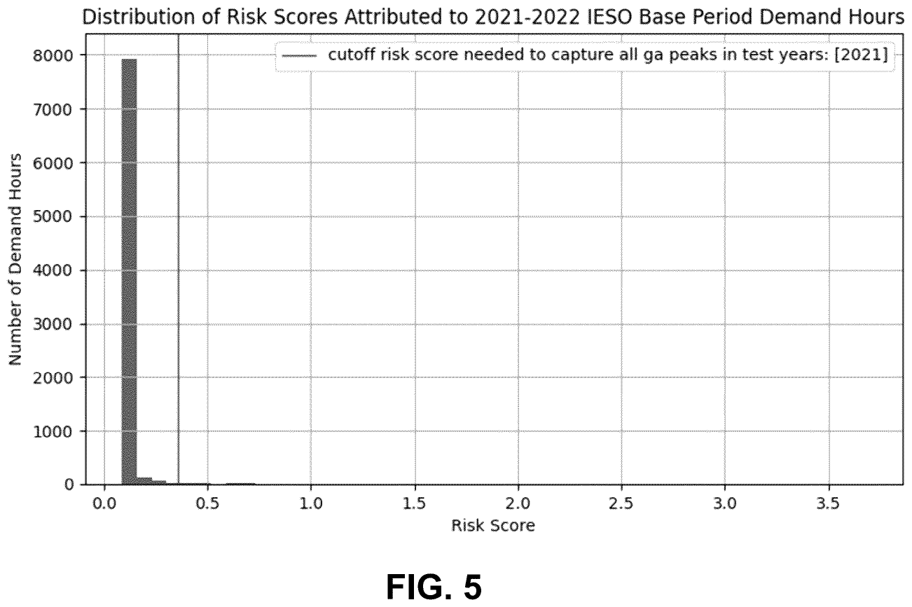

FIG. 5 is a histogram showing a distribution of risk scores for an example data set, in accordance with an embodiment. In particular, FIG. 5 shows the operation of likelihood estimator 206 applied to the 2021-2022 IESO global adjustment base period, i.e., likelihood that each hour of the year (8760 hours total) is one of five peak demand hours. The vertical line indicates a “cut-off” score that is less than or equal to those assigned to the five peak demand hours. As shown, the operation of likelihood estimator 206 isolated a population of 177 hours among the total 8760 hours that contains all peak demand hours. A customer could, for example, avoid all peak demand hours by utilizing battery power for each of the 177 hours. Thus, this population provides an indication of the amount of battery capacity power given the risk evaluation enabled by likelihood estimator 206.

In some embodiments, a time period resolution other than an hour may be used. For example, a prediction can be computed for a time period resolution of 20 minutes, 30 minutes, 90 minutes, 2 hours, 5 hours, and so on. The desired time period resolution may be selected based on the pricing incentives offered by the system operator of a particular region.

Recommendation generator 208 is configured to transform likelihood metrics (e.g., risk scores) generated by likelihood generator 206 into recommendations, e.g., to reduce electricity consumption in a future time period if the likelihood metric indicates a high likelihood of being a peak demand time period.

Various approaches to transform likelihood metrics into recommendations are possible, which may differ from embodiment to embodiment.

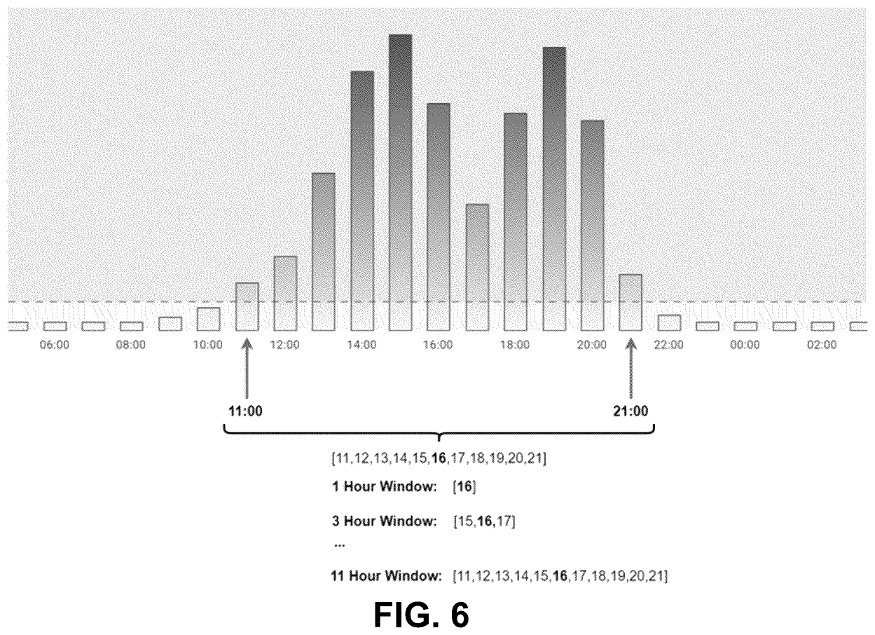

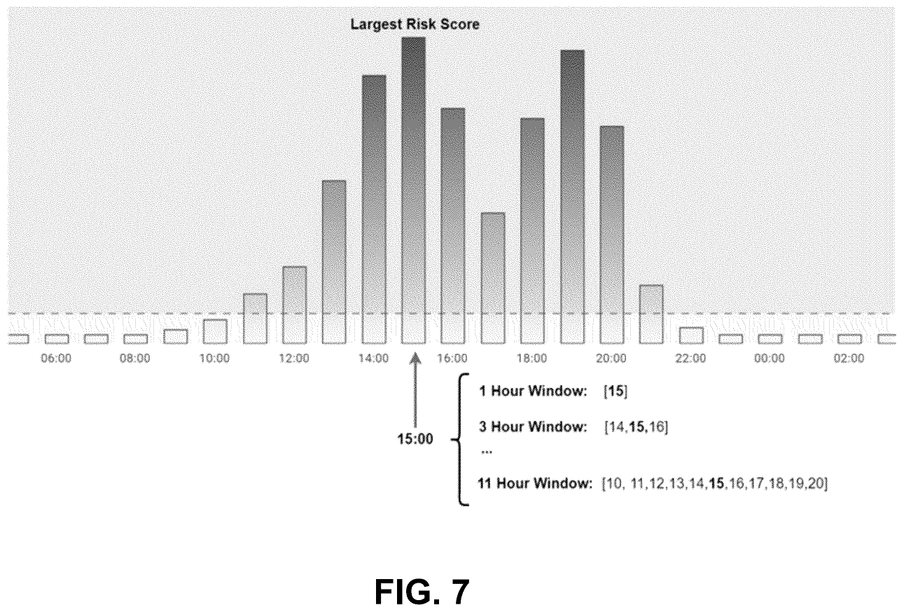

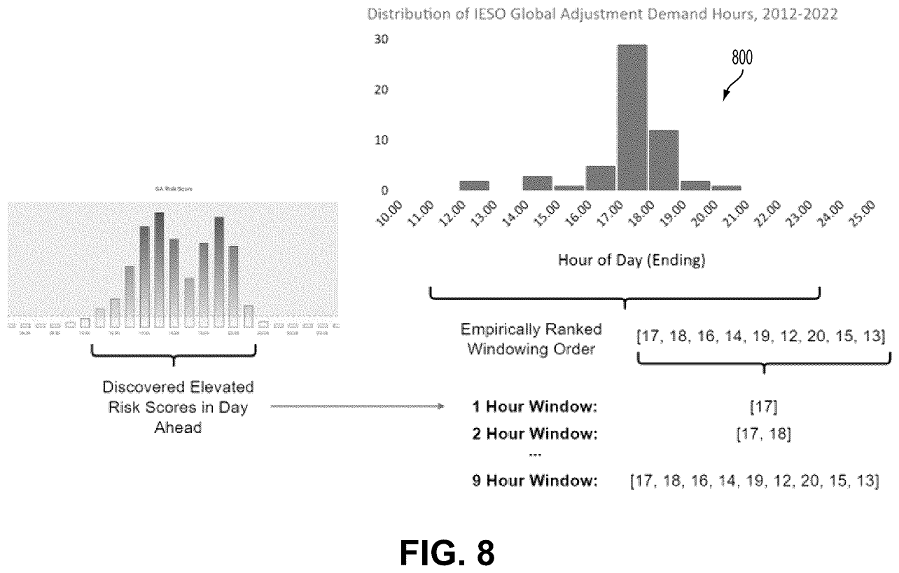

One example approach is referred to herein as the “median window” approach. In accordance with this approach, as shown in FIG. 6, on days that have elevated risk scores relative to a predefined baseline risk score, the hours in which the first and last elevated scores occur are identified by recommendation generator 208. Recommendation generator 208 recommends to one or more end users to cease or reduce their consumption of electricity over a window of time centered around the median hour amongst hours falling within the identified hours. The width of this window (which may be referred to as an “avoidance window”) may be predefined, and may be, for example, 1 hour, 3 hours, 5 hours, and so on.

For example, if there are elevated risk scores identified from 11:00-21:00 (inclusive, hour ending), the “median hour” would be 16:00, meaning a 3-hour avoidance window as produced by this “median window” approach would range from 15:00-17:00 (inclusive, hour ending). Meanwhile, an 11-hour avoidance window would range from 11:00-21:00 (inclusive, hour ending). Meanwhile, a 1-hour avoidance window would be an hour starting at 16:00.

Another example approach is referred to herein as the “max risk” approach. In accordance with this approach, as shown in FIG. 7, on days that have elevated risk scores relative to a predefined baseline risk score, the hour in which the largest risk score occurs is identified by recommendation generator 208. Recommendation generator 208 recommends to one or more end users to cease or reduce their consumption of electricity over a window of time centered around that identified hour. As before, the width of this window (which may be referred to as an “avoidance window”) may be predefined, and may be, for example, 1 hour, 3 hours, 5 hours, and so on.

For example, if the max risk occurs at 15:00 (hour ending), a 3-hour avoidance window as produced by this “max risk” approach would range from 14:00-16:00 (inclusive, hour ending). Meanwhile, an 11-hour avoidance window would range from 10:00-20:00 (inclusive, hour ending). Meanwhile, a 1-hour avoidance window would be an hour starting at 15:00.

Yet another example approach is referred to herein as the “historical rate of occurrence” approach. In accordance with this approach, as shown in FIG. 8, the likelihood metrics generated by likelihood estimator 206 are used to determine whether or not a day is likely to contain a peak demand hour, e.g., by comparison to a predefined baseline risk score. Then, historical data is used to predict when a peak demand hour will occur within that day.

In the case of IESO peak demand hours (as published on the IESO website), histogram 800 shows a distribution of times of day at which peak demand hours have occurred in the past. This distribution provides which hours have most frequently been peak demand hours in the past. Recommendation generator 208 recommends to one or more end users to cease or reduce their consumption of electricity over a window of time spanning the n hours in which peak demand hours have occurred the most frequently in the past. The total width n of this window (which may be referred to as an “avoidance window”) may be predefined, and may be, for example, 1 hour, 3 hours, 5 hours, and so on.

In some embodiments, ties can be broken by looking at the occurrence of demand hours that are large, but not necessarily peaks (e.g., in the case of IESO, a distribution of top 10 demand hours instead of top 5), and then determining what occurrence rates are in that distribution amongst the tied hours.

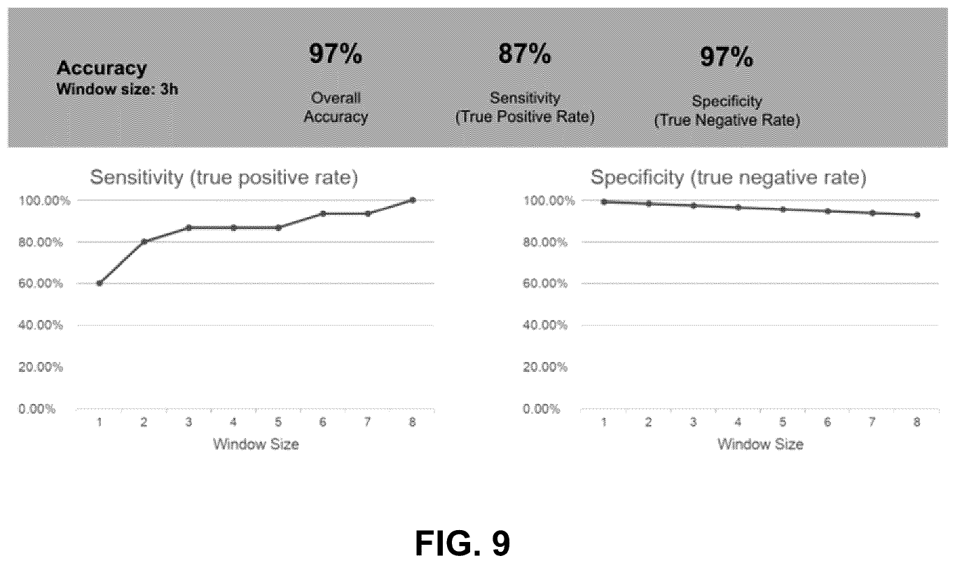

FIG. 9 are graphs showing, respectively, sensitivity and specificity as a function of the size of the avoidance window, when using the “historical rate of occurrence” approach. As shown, the highest overall accuracy was 97%, obtained for an avoidance window size of 3 hours.

In some embodiments, recommendation generator 208 generates an electronic signal of the recommendation for transmission to an electronic device operated by an end user. The electronic signal may signal a recommended reduction of electricity consumption that includes deactivating or reducing an activation level of at least one end user asset 150. Reducing an activation level may include, for example, reducing the setting of a home heating, ventilation, and air conditioning system.

In some embodiments, the electronic signal may include a plurality of action requests for a plurality of end user assets. Each action request may include a desired action in support of the recommended reduction, e.g., to reduce demand by adjusting a thermostat setpoint or pausing EV charging, to draw power from a BESS, or the like.

In some embodiments, the recommended reduction may take into account a given end user's power consumption preferences or requirements. Each end user may specify his/her own power consumption preferences or requirements for one or more end user assets 150.

In some embodiments, recommendation generator 208 generates an electronic signal of the recommendation for transmission to a device operated by a system operator, e.g., an operator computing device 160. The electronic signal may signal a recommended reduction that includes issuance of a curtailment request by the system operator.

Referring again to FIG. 3, electronic data store 210 may include a combination of non-volatile and volatile memory. In the depicted embodiment, electronic data store 210 is organized as a database. Such database may be a conventional relational database such as a SQL-based database, an object-oriented database, a NoSQL database, or the like.

Electronic data store 210 may store data received from data source devices 140. Electronic data store 210 may store model parameters of machine learning model 212 such as model weights, hyperparameters, or the like. Electronic data store 210 may store feature embeddings of historical peak demand time periods (which may be referred to as historical embeddings). Electronic data store 210 may store other comparator embeddings, against which inference embeddings may be compared to make predictions.

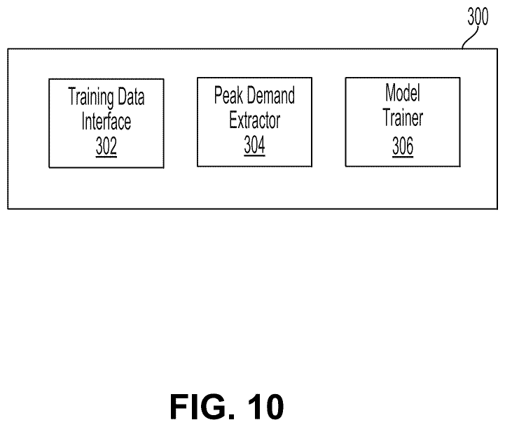

FIG. 10 is a schematic diagram of a configuration system 300 that performs initial configuration of prediction system 200 (including training of machine learning models therein), in accordance with an embodiment. As depicted, configuration system 300 includes a training data interface 302, a peak demand extractor 304, and a model trainer 306.

Training data interface 302 is configured to receive data transmissions from one or more data source devices 140, e.g., by way of network 50. Such data transmissions encode data useful for training machine learning model(s) of prediction system 200. Training data interface 302 may pre-process such data, e.g., by applying normalization to data values, filtering such data, removing outliers, or the like. Such data becomes training data that can be used to train machine learning model(s) of prediction system 200.

Training data interface 302 processes the received data to generate a feature record (e.g., in the form of a feature vector) for a plurality of historical time periods within a training data set.

In some embodiments, training data interface 302 generates a feature record to include one or more features described above with reference to inference data interface 202. As will be appreciated, the set of features used in the training data should match the set of features used in the inference data.

Peak demand extractor 304 is configured to process the set of feature records generated by training data interface 302 to identify those feature records corresponding to historic peak demand time periods. Peak demand extractor 304 may use information regarding historic peak demand periods received from a system operator data source, e.g., a public repository or other source of published data.

Peak demand extractor 304 may generate an indicator indicating that a feature record corresponds to a historic peak demand time period.

Model trainer 306 is configured to train one or more machine learning models of prediction system 200. For example, in embodiments where embedding generator 204 includes an embedding model, model trainer 306 trains that embedding model.

In the depicted embodiment, model trainer 306 is configured to train an embedding model within an embedding layer of a Siamese neural network architecture.

In accordance with a Siamese neural network architecture, model trainer 306 trains the embedding model using “positive” and “negative” examples, which are examples of feature records (e.g., as described in a feature vector) that are considered, respectively, similar or not similar to an “anchor” feature record.

Model trainer 306 groups feature records into “anchor”, “positive”, and “negative” triplets. A positive feature record is a record that is similar to an anchor feature record. Conversely, a negative feature record is a record that is not similar to an anchor feature record. For example, when an anchor feature record corresponds to a peak demand time period, positive feature records are those that correspond to other peak demand time periods while negative feature records are those that correspond to non-peak demand time periods. Similarly, when an anchor feature record corresponds to a non-peak demand time period, positive feature records are those that correspond to other non-peak demand time periods while negative feature records are those that correspond to peak demand time periods.

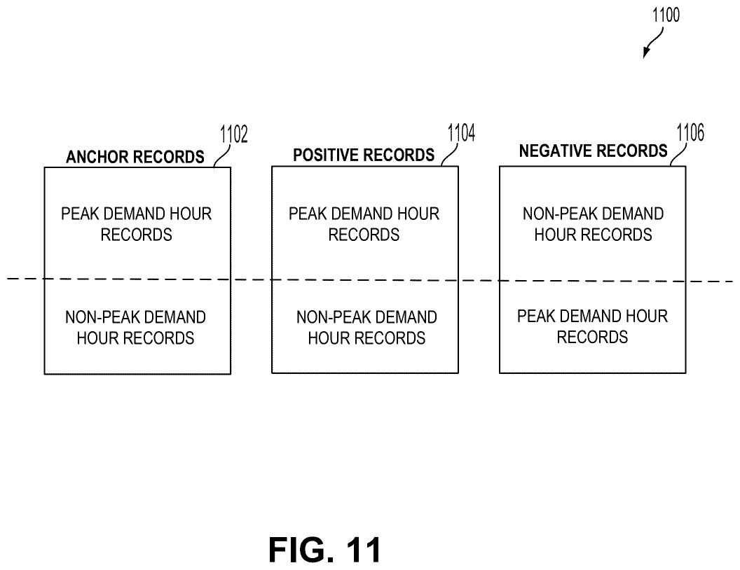

FIG. 11 schematically depicts a data set 1100 comprising a table 1102 of anchor records, a table 1104 of positive records, and a table 1106 of negative records, in accordance with an embodiment. Each of tables 1102, 1104, and 1106 may be of the same size, and their indices may be used to create the aforementioned triplets. For example, a triplet may be constructed by taking a record from each table at a given row.

For the given data set, the number of peak demand time periods is far fewer than the number of non-peak demand time periods. For instance, in Ontario, Canada, there are 5 peak hours (0.06%) and 8,755 non-peak hours (99.94%) in a standard year. As such, to have enough negative feature records to be assigned to all non-peak anchor feature records, peak demand hour feature records were replicated to fill table 1106. In some embodiments, feature records may be randomly sampled (from peak or non-peak demand time periods, as appropriate) to construct tables 1102 and 1104.

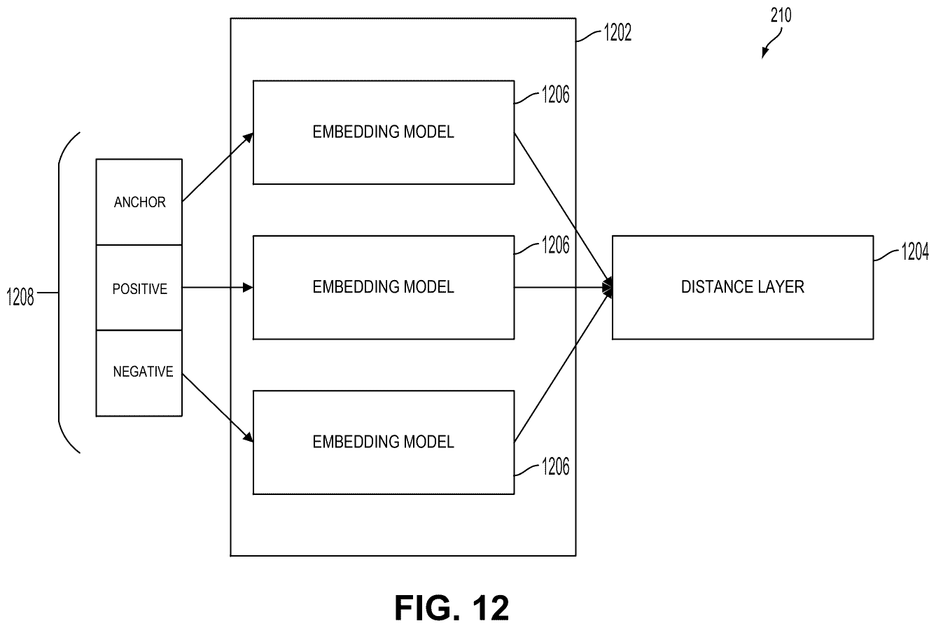

FIG. 12 is a schematic diagram of machine learning model 212 having a Siamese neural network architecture, in accordance with an embodiment. As depicted, machine learning model 212 includes an embedding layer 1202 and a distance layer 1204.

Embedding layer 1202 includes three embedding models 1206. In the depicted embodiment, each embedding model 1206 is an instance of the same feed-forward neural network, e.g., trained in the same way and/or having the same model weights. Each embedding model 1206 receives a corresponding feature record of a triplet 1208; namely, one embedding model 1206 receives an anchor feature record of triplet 1208; another embedding model 1206 receives a positive feature record of triplet 1208; and yet another embedding model 1206 receives a negative feature record of triplet 1208.

Each of the embedding models 1206 outputs a feature embedding. Collectively, embedding models 1206 output (i) an anchor feature embedding (e.g., as represented by an anchor embedding vector), (ii) a corresponding positive (i.e., similar) feature embedding (e.g., as represented by a positive embedding vector); and (iii) a corresponding negative (i.e., not similar) feature embedding (e.g., as represented by a negative embedding vector). These feature embeddings are passed to distance layer 1204, which computes (i) a distance between the anchor feature embedding and its corresponding positive feature embedding, which may be referred to as an “AP distance”; and (ii) a distance between the anchor feature embedding and its corresponding negative feature embedding, which may be referred to as an “AN distance”.

In some embodiments, distance layer 1204 is used only during a training phase of machine learning model 212. In some embodiments, distance layer 1204 is used during both a training phase and inference phase of machine learning model 212.

Model trainer 306 uses a loss function to train embedding model 1206, as follows:

L(A, P, N)=max(|f(A)−f(P)|²−|f(A)−f(N)|²+margin, 0)

where ∥f(A)−f(P)∥² corresponds to the AP distance and ∥f(A)−f(N)∥² corresponds to the AN distance, and the function f(X) refers to an embedding of X.

As shown, the loss is computed using the AP distance minus the AN distance. This results in a loss function that increases in value when two similar examples have a large embedding distance between them, and decreases in value when two dissimilar examples have a large embedding distance between them. The inclusion of the “margin” term avoids the trivial solution of 0 for any distances during an optimization process. This loss function may be referred to as a “triplet loss function”. The inclusion of a max function is intended to eliminate incentive for the optimization process to reduce a particular triplet's AP distance relative to its AN distance beyond what is defined as necessary in the margin term.

In other embodiments, machine learning model 212 may have a different architecture suitable for generating a feature embedding (e.g., capable of generating an output having multiple values corresponding to the various dimensions of a feature embedding). Examples include matrix factorization techniques such as singular value decomposition, principal component analysis (PCA), kernel-based methods such as polynomial kernels and radial-basis function (RBF), and various neural net architectures such as convolutional neural networks (CNN), and recursive neural networks (RNN), and transformers.

As noted, configuration system 300 may be used to perform initial configuration of prediction system 200. Additionally, configuration system 300 may be used to update prediction system 200, e.g., as new training data and/or improved training methodologies become available.

Inference data interface 202, embedding generator 204, likelihood estimator 206, recommendation generator 208, training data interface 302, peak demand extractor 304, and model trainer 306 may be implemented using a suitable combination of software and hardware components. Software components may be implemented using conventional programming languages such as Java, J#, C, C++, C#, Perl, Visual Basic, Ruby, Scala, etc. These software components may be in the form of one or more executable programs, scripts, routines, statically/dynamically linkable libraries, or the like.

Embodiments have been described in which an inference embedding is compared to one or more historical embeddings to determine similarity. In other embodiments, an inference embedding is compared to a different comparator embedding. For example, the comparator embedding may be an embedding that reflects an electricity demand threshold set by a utility or system operator. The demand threshold may be a threshold that the utility or system operator desires to not be exceeded. In such circumstances, prediction system 200 may be used by a utility or system operator to trigger the issuance of a curtailment request. In some embodiments, recommendation generator 208 is configured to issue a curtailment request for a future time period, e.g., upon predicting that such time period will be a peak demand time period.

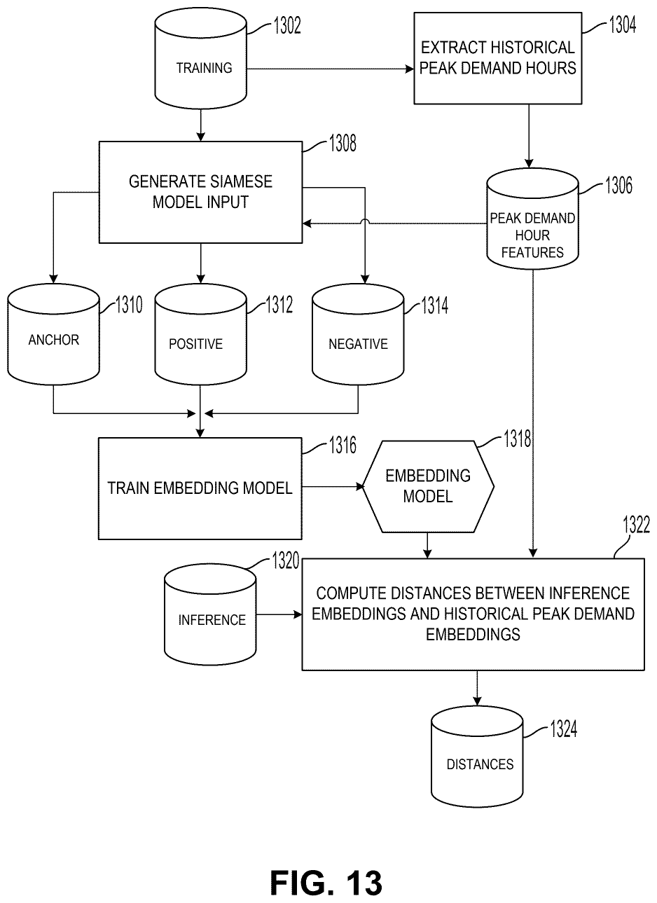

The operation of prediction system 200 and configuration system 300 is further described with reference to the flow diagram of FIG. 13, in accordance with an embodiment. Blocks 1302 through 1318 correspond to a training stage of operation, while blocks 1320 through 1324 correspond to an inference stage of operation.

At block 1302, a training data set is received at configuration system 300 by way of training data interface 302. Training data interface 302 processes the training data to generate a feature record for each historical time period in the training data set.

At block 1304, peak demand extractor 304 processes the feature records to identify those records that correspond to historic peak demand time periods. Peak demand extractor 304 generates indicators indicating the identified feature records to model trainer 306. At block 1306, peak demand extractor 304 stores the historical peak demand features.

At block 1308, model trainer 306 generates the inputs required by the Siamese neural network architecture. Model trainer 306 groups the feature records for historical time periods into anchor examples (block 1310), positive examples (block 1312), and negative examples (block 1314).

At block 1316, model trainer 306 trains an embedding model (e.g., embedding model 1206) using the anchor, positive, and negative examples. This results in a trained embedding model at block 1318.

At block 1320, prediction system 200 receives inference data for making predictions of whether a particular future time period will be a peak demand time period. The data may be received by way of inference data interface 202. Inference data interface 202 generates a feature record of the inference data for each future time period.

At block 1322, embedding generator 204 generates inference embeddings from the feature records of the inference data. Embedding generator 204 also generates historical embeddings from the feature records of the historical peak demand time periods. In some cases, such historical embeddings are generated at a prior time and are retrieved from storage, e.g., from electronic data store 210. For each inference embedding, likelihood estimator 206 computes distances between that inference embedding and the historical embeddings. At block 1322, the distances are obtained. Using the computed distances, likelihood estimator 206 generates a distance metric for each of the inference embeddings (block 1324). The distance metrics can be used by recommendation generator 208 to generate an electronic signal of a recommended reduction of electricity consumption during the given future time period, e.g., upon calculating a likelihood metric indicating a high likelihood that the given future time period is a peak demand time period.

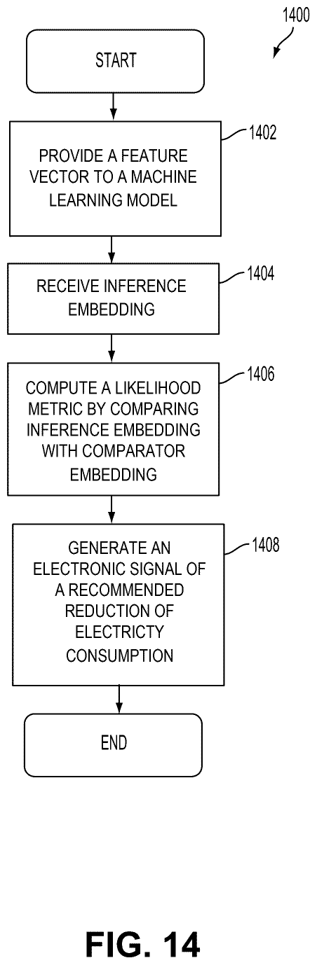

The operation of prediction system 200 is further described with reference to the flowchart depicted in FIG. 14, in accordance with an embodiment. As depicted, prediction system 200 performs example operations depicted at blocks 1400 and onward.

At block 1402, a feature vector representative of a given future time period is provided to a machine learning model trained to generate an embedding therefrom. Such machine learning model may, for example, be machine learning model 212.

At block 1404, an inference embedding of the given future time period is received from the machine learning model.

At block 1406, a likelihood metric indicative of a likelihood that the given future time period is a peak demand time period is computed. Computation of this metric includes comparing the inference embedding with at least one comparator embedding. In some cases, the comparator embedding may be representative of a historical peak demand time period. In other cases, the comparator embedding may reflect an electricity demand threshold. Such threshold may be set, for example, by a system operator or utility.

At block 1408, an electronic signal of a recommended reduction of electricity consumption during the given future time period is generated, taking into account the likelihood metric. In some cases, the electronic signal may be transmitted to a device operated by an end user. In such cases, the electronic signal may signal a recommendation that includes deactivating or reducing an activation level of at least one end user asset 150. In some cases, the electronic signal may be transmitted to a system operator device such as, e.g., an operator computing device 160. In such cases, the electronic signal may signal a recommendation that includes issuance of a curtailment request by the system operator.

It should be understood that steps of one or more of the blocks depicted in FIG. 13 and FIG. 14 may be performed in a different sequence or in an interleaved or iterative manner. Further, variations of the steps, omission or substitution of various steps, or additional steps may be considered.

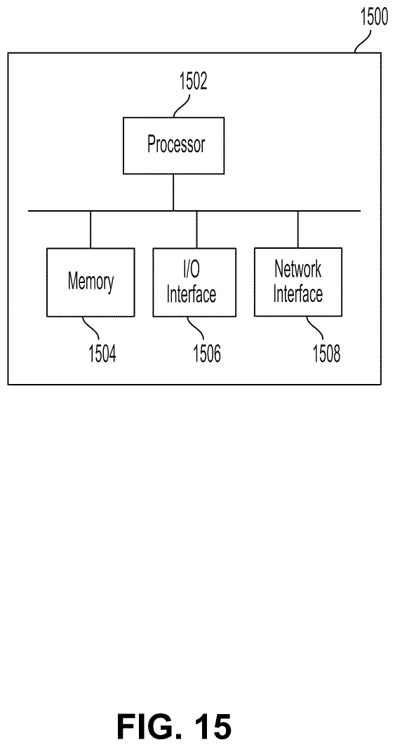

FIG. 15 is a schematic diagram of computing device 1500 which may be used to implement prediction system 200 and/or configuration system 300, in accordance with an embodiment.

As depicted, computing device 1500 includes a processing subsystem with one or more processors 1502, one or more memories 1504, and a communication subsystem with one or more I/O interfaces 1506, and one or more network interfaces 1508.

Each processor 1502 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Processor 1502 may, for example, include one or more central processing unit (CPU), a graphics processing unit (GPU), a quantum processing unit (QPU), or the like.

Memory 1504 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1506 enables computing device 1500 to interconnect with one or more input devices, such as a keyboard, mouse, camera, touch screen, and a microphone, or with one or more output devices such as a display screen and a speaker.

Each network interface 1508 enables computing device 1500 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX, Li-Fi), SS7 signaling network, fixed line, local area network, wide area network, and others, including any combination of these.

For simplicity only, one computing device 1500 is shown, but management system 200 may include multiple computing devices 1500. The computing devices 1500 may be the same or different types of devices. The computing devices 1500 may be connected in various ways including directly coupled, indirectly coupled via a network, and distributed over a wide geographic area and connected via a network (which may be referred to as “cloud computing”).

For example, a computing device 1500 may be a server, network appliance, set-top box, embedded device, computer expansion module, personal computer, laptop, personal data assistant, cellular telephone, smartphone device, UMPC tablets, video display terminal, gaming console, or any other computing device capable of being configured to carry out the methods described herein.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which may be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Of course, the above-described embodiments are intended to be illustrative only and in no way limiting. The described embodiments are susceptible to many modifications of form, arrangement of parts, details, and order of operation. The disclosure is intended to encompass all such modifications within its scope, as defined by the claims.

What is claimed is:

1. A computer-implemented system for reducing electricity consumption during periods of peak demand, the system comprising:
a processing subsystem that includes one or more processors and one or more memories coupled with the one or more processors, the processing subsystem configured to cause the system to:
provide a feature vector representative of a given future time period to a machine learning model trained to generate an embedding therefrom;
receive from the machine learning model an inference embedding of the given future time period;
compute a likelihood metric indicative of a likelihood that the given future time period is a peak demand time period, by comparing the inference embedding with at least one comparator embedding; and
generate an electronic signal of a recommended reduction of electricity consumption during the given future time period, taking into account the likelihood metric.

2. The computer-implemented system of claim 1, wherein the at least one comparator embedding is representative of a historical peak demand time period.

3. The computer-implemented system of claim 1, wherein the at least one comparator embedding reflects an electricity demand threshold.

4. The computer-implemented system of claim 1, wherein the given future time period is a given future hour, and the likelihood metric indicates a likelihood that the given future hour is a peak demand hour.

5. The computer-implemented system of claim 1, wherein the given future time is at least one day in the future.

6. The computer-implemented system of claim 1, wherein the machine learning model is trained using training data including historical time periods of peak demand.

7. The computer-implemented system of claim 1, wherein the machine learning model is trained using a Siamese neural network architecture.

8. The computer-implemented system of claim 7, wherein the machine learning model is trained using training data organized into anchor examples, positive examples, and negative examples, each corresponding to a respective historic time period.

9. The computer-implemented system of claim 1, wherein the likelihood metric is computed using a distance metric measuring a distance between the inference embedding and the at least one comparator embedding.

10. The computer-implemented system of claim 9, wherein the at least one comparator embedding includes a plurality of comparator embeddings, and the distance metric is an average of distances between the inference embedding and the plurality of comparator embeddings.

11. The computer-implemented system of claim 1, wherein the electronic signal of a recommended reduction of electricity consumption is transmitted to a device operated by an end user.

12. The computer-implemented system of claim 11, wherein the recommended reduction includes deactivating or reducing an activation level of an end user asset.

13. The computer-implemented system of claim 1, wherein the electronic signal of a recommended reduction of electricity consumption is transmitted to a device operated by a system operator.

14. The computer-implemented system of claim 13, wherein the recommended reduction includes issuance of a curtailment request by the system operator.

15. A computer-implemented method for reducing electricity consumption during periods of peak demand, the method comprising:
providing a feature vector representative of a given future time period to a machine learning model trained to generate an embedding therefrom;
receiving from the machine learning model an inference embedding of the given future time period;
computing a likelihood metric indicative of a likelihood that the given future time period is a peak demand time period, by comparing the inference embedding with at least one comparator embedding; and
generating an electronic signal of a recommended reduction of electricity consumption during the given future time period, taking into account the likelihood metric.

16. The computer-implemented method of claim 15, further comprising training the machine learning model using a Siamese neural network architecture.

17. The computer-implemented method of claim 16, further comprising organizing training data into anchor examples, positive examples, and negative examples, each corresponding to a respective historic time period.

18. The computer-implemented method of claim 15, further comprising training the machine learning model using training data including historical time periods of peak demand.

19. The computer-implemented method of claim 15, further comprising transmitting the electronic signal of a recommended reduction of electricity consumption to a device operated by an end user.

20. The computer-implemented method of claim 19, wherein the recommended reduction includes deactivating or reducing an activation level of an end user asset.

21. The computer-implemented method of claim 15, further comprising transmitting the electronic signal of a recommended reduction of electricity consumption to a device operated by a system operator.

22. The computer-implemented method of claim 21, wherein the recommended reduction includes issuance of a curtailment request by the system operator.
